(19) United States
(12) Patent Application Publication
(10) Pub. No.: US 2008/0157667 A1
(43) Pub. Date: Jul. 3, 2008

(54) METHOD OF MANUFACTURING SOFT MOLD TO SHAPE BARRIER RIB, METHOD OF MANUFACTURING BARRIER RIB AND LOWER PANEL, AND PLASMA DISPLAY PANEL

(75) Inventors: DONG-YOL YANG, Daejeon (KR); Seung-Min Ryu, Daejeon (KR); Suk-Hea Park, Daejeon (KR); Jong-Seo Choi, Suwon-si (KR); Kwi-Seok Choi, Suwon-si (KR); Beom-Wook Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/964,993

(22) Filed: Dec. 27, 2007

(30) Foreign Application Priority Data
Dec. 29, 2006 (KR) 2006-138904
May 31, 2007 (KR) 2007-53419

(51) Int. Cl. H01J 1/62; H01J 9/02

(52) U.S. Cl. 313/582; 445/24

(57) ABSTRACT

A method of manufacturing a soft mold to shape a barrier rib, a method of manufacturing a barrier rib and a lower panel, and a plasma display panel (PDP) including the same. The method of manufacturing the soft mold includes: providing a metal mold on which a barrier rib pattern is formed, by alternating channels and projections; disposing a polymer sheet opposite the metal mold; pressing the metal mold into the polymer sheet, to form the soft mold, which has an inverted image of the barrier rib pattern formed on the surface thereof; and releasing the soft mold from the metal mold.

### CROSS-REFERENCE TO RELATED APPLICATIONS

This application claims the benefit of Korean Application Nos. 2006-138904, filed Dec. 29, 2006, and 2007-53419, filed May 31, 2007, in the Korean Intellectual Property Office, the disclosures of which are incorporated herein by reference.

### BACKGROUND OF THE INVENTION

1. Field of the Invention

Aspects of the present invention relate to a method of manufacturing a plasma display panel (PDP), and more particularly, to a method of manufacturing a soft mold, and a method of manufacturing a barrier rib of a PDP using the soft mold.

2. Description of the Related Art

In a plasma display panel (PDP), barrier ribs are interposed between an upper substrate and a lower substrate, to partition a plurality of discharge spaces. A plurality of sustain electrodes and address electrodes, having predetermined patterns, are formed across the discharge spaces, to cause display discharges in the discharge spaces. The discharges create ultraviolet rays that excite phosphor layers, thereby forming a predetermined image.

The barrier ribs prevent electrical and optical crosstalk between the discharge spaces, thereby improving display quality/color purity. Also, the barrier ribs provide a surface upon which fluorescent materials are coated to produce the luminance of the PDP The barrier ribs partition the discharge spaces, to define unit pixels that are formed by red (R), green (G), and blue (B) discharge spaces. The barrier ribs define a cell pitch between the discharge spaces, to determine the resolution of an image. As described above, the barrier ribs are essential for improving image quality and luminous efficiency. Thus, extensive research has been conducted on barrier ribs, due to the recent demand for large-area high-resolution panels.

Conventionally, a barrier rib may be manufactured using a screen printing method, a sandblasting method, an etching method, or a photolithographic method. Screen printing is a simple, low-cost method, which includes aligning a screen with a lower substrate, and then printing and drying a paste, which is used to form a barrier rib. The printing and drying is generally repeated several times. When the screen is not precisely aligned with the substrate, during the printing process, the barrier rib may be misaligned. Therefore, a barrier rib manufactured by screen printing may be formed with low precision, and the top surface of the barrier rib may not be planar.

Sandblasting is the most widely used method, because it is advantageous for large-area panels. However, there is a technical limit in forming a high-resolution barrier rib, using physical shock applied to etching particles, due to highly pressured air. Also, when the dry film and the barrier rib paste layer are misaligned, when laminating a dry film resist for an etch stop layer, on a barrier rib paste layer, the resulting barrier rib may be misaligned. In addition, when the time taken to delaminate the dry film is extended, the barrier rib may be delaminated from a dielectric layer, so that a barrier rib having a desired shape cannot be obtained.

The etching method includes attaching a barrier rib forming material to a substrate, and etching the material using an appropriate etchant. In the etching method, a barrier rib may be stably shaped, a closed-type high-resolution barrier rib may be formed, and the number of process operations can be reduced, as compared with the conventional sandblasting method. Therefore, the etching method is sufficiently competitive in terms of quality and price. However, since the etching method involves mechanical and chemical etching processes, large amounts of materials may be consumed, which can lead to environmental pollution. Above all, when using the etching method, a barrier rib having a uniform shape cannot be formed for large-area PDPs, and only a small range of materials can be used as the etchable barrier rib forming material.

The photolithographic method may include: coating a photosensitive paste material, which contains a ceramic material, on a substrate; drying the photosensitive paste to a desired thickness; selectively exposing the photosensitive paste to light, by aligning a mask; shaping a barrier rib by removing the exposed portion, using a developing solution; and manufacturing a final barrier rib through a sintering process. The photolithographic method is simpler than the above-described etching method, because a process of forming photoresist is omitted. However, shapes of barrier ribs formed using the photolithographic method vary, according to exposure conditions. Specifically, when a thick photosensitive paste layer, containing a glass powder and ceramic powder, is exposed to light, it is difficult to obtain a uniform result, due to scattering of the glass and ceramic powder. Further, when manufacturing large-area panels, such as PDPs, using the photolithographic method, maintaining uniform exposure conditions over a large area is difficult, the photosensitive paste is expensive, and a substantial amount of material is removed, thereby producing a large quantity of industrial waste.

### SUMMARY OF THE INVENTION

Aspects of the present invention provide a method of manufacturing a soft mold, which is accurately shaped, and has highly stable dimensions, in order to form a high-resolution barrier rib pattern.

Aspects of the present invention provide a method of manufacturing a barrier rib, and a lower panel for a plasma display panel (PDP), using a molding process.

Aspects of the present invention provide a PDP manufactured using a molding process.

According to an aspect of the present invention, there is provided a method of manufacturing a soft mold. The method includes: providing a metal mold having a barrier rib pattern formed of a plurality of projections that are separated by channels; disposing a polymer sheet opposite the metal mold; transferring the metal mold onto the polymer sheet, under pressure, to form the soft mold, which has a surface on which an inverted image of the barrier rib pattern is formed; and releasing the soft mold from the metal mold.

According to another aspect of the present invention, there is provided a method of manufacturing a barrier rib for a PDP. The method includes: preparing a mold having a patterned surface to shape a barrier rib; disposing a dielectric sheet opposite the mold; and transferring a pattern of the mold onto the dielectric sheet, under pressure, to shape a rib portion, and a base portion disposed on the reverse side of the rib portion.

According to yet another aspect of the present invention, there is provided a method of manufacturing a lower panel of a PDP. The method includes: preparing a mold having a patterned surface, to shape a barrier rib,; disposing a dielectric sheet opposite the mold; transferring a pattern of the mold onto the dielectric sheet, under pressure, to shape the dielectric sheet to have a rib portion having projections and a substantially flat base portion; disposing the base portion of the dielectric sheet, upon a plurality of exposed electrodes of a substrate; and bonding the dielectric sheet to the substrate, under pressure.

According to another aspect of the present invention, there is provided a PDP including: an upper substrate and a lower substrate disposed opposite each other; a barrier rib layer interposed between the upper and lower substrates and parallel to the upper and lower substrates, the barrier rib including a substantially flat base portion, and a rib portion comprising projections to at least partially partition a plurality of discharge spaces; a plurality of discharge electrodes extending across the discharge spaces; phosphor layers disposed on inner surface of the discharge spaces; and a discharge gas filled in the discharge spaces.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings of which:

FIG. 1 is a flowchart illustrating a method of manufacturing a soft mold, according to an exemplary embodiment of the present invention;

FIGS. 2A through 2D are cross-sectional views illustrating a method of forming a photoresist (PR) pattern, according to an exemplary embodiment of the present invention;

FIG. 3 is a photographic image of an exemplary PR pattern, formed using the method of FIGS. 2A through 2D;

FIGS. 4A through 4D are cross-sectional views illustrating a method of forming a silicon mold, according to an exemplary embodiment of the present invention;

FIG. 5 is a photographic image of an exemplary mold pattern, formed in a silicon mold manufactured using the method of FIGS. 4A through 4D;

FIGS. 6A through 6C are cross-sectional views illustrating a method of forming a metal mold, according to an exemplary embodiment of the present invention;

FIGS. 7A through 7D are cross-sectional views illustrating a method of forming a soft mold, using a metal mold manufactured using the method of FIGS. 6A through 6D, according to an exemplary embodiment of the present invention;

FIG. 8A is a perspective view of an exemplary soft mold manufactured using the method of FIGS. 7A through 7D, according to an exemplary embodiment of the present invention;

FIG. 8B is a partially cutaway perspective view taken along a line A-A of FIG. 8A, according to an exemplary embodiment of the present invention;

FIG. 9 is a photographic image of an exemplary pattern of a soft mold similar to that illustrated in FIG. 8A;

FIGS. 10A through 10D are cross-sectional views illustrating a method of manufacturing a large-area soft mold, according to an exemplary embodiment of the present invention;

FIG. 11 is a flowchart illustrating a method of manufacturing a lower panel for a plasma display panel (PDP), according to an exemplary embodiment of the present invention;

FIGS. 12A through 12F are cross-sectional views illustrating the method of FIG. 11, according to an exemplary embodiment of the present invention; and

FIG. 13 is an exploded perspective view of a PDP, according to an exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of present invention, by referring to the figures.

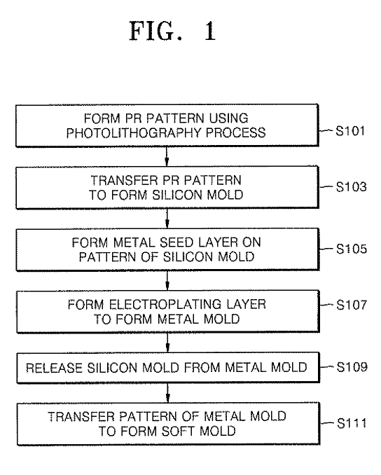

FIG. 1 is a flowchart illustrating a method of manufacturing a soft mold, according to an exemplary embodiment of the present invention. In operation S101, a photoresist (PR) pattern is formed on a substrate, using a photolithography process. A silicon mold is formed using the PR pattern as a mold, and using silicon rubber as a mold material, in operation S103. Thereafter, a metal seed layer, for an electroplating process, is deposited on the silicon mold, in operation S105. In operation S107, a metal mold is then manufactured by forming an electroplating layer on the metal seed layer of the silicon mold. Next, the metal mold is released from the silicon mold, in operation S109. The metal mold is imprinted on a polymer sheet, to obtain a soft mold, in operation S111.

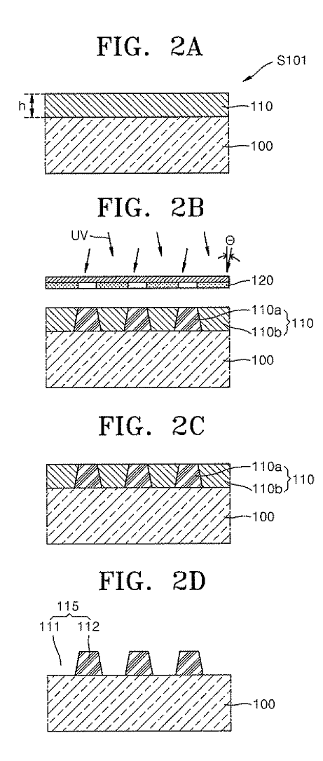

Hereinafter, operations S101 through S111 will be described in detail. FIGS. 2A through 2D are cross-sectional views illustrating operation S101. To begin with, the base substrate 100 is prepared. The base substrate 100 may be a glass substrate, which has a low surface roughness and a uniform surface, even if it has a large area.

Referring to FIG. 2A, a PR layer 110 is formed on the base substrate 100. The PR layer 110 may be obtained by coating a photosensitive resin on the base substrate 100. The photosensitive resin may be cured with radiated light. For example, the PR layer 110 may be a negative-type, dry film resist (DFR) layer. A coated height “h” of the PR layer 110 corresponds to the height of a finally obtained barrier rib. The height “h” may be in the range of about 150 to 250 μm. In order to form the PR layer 110 to a predetermined height, a DFR laminated layer may be prepared by stacking a plurality of thin DFR layers.

Referring to FIG. 2B, after forming the PR layer 110 on the base substrate 100, a photo mask 120 is aligned in a predetermined position, and irradiated with ultraviolet (UV) light. In this case, UV light may be radiated at a non-perpendicular angle, onto a front surface of the photo mask 120. The UV light may be radiated at a predetermined inclination angle 0 to the photo mask 120. As a result, sides of the pattern can be inclined, as illustrated in FIG. 2D. In another inclined radiation method, the base substrate 100, on which the PR layer 110 is coated, may be inclined to a desired angle, and irradiated with UV light. Referring to FIG. 2C, an exposed portion 110a, which is selectively exposed by the photo mask 120, is cured due to a crosslinking reaction, or a polymerization reaction, and an unexposed portion 110b, which is not exposed to UV light, remains uncured.

Referring to FIG. 2D, after the UV light exposure, a developing process is performed. During the developing process, the uncured portion 110b is removed, to form channel portions 111. After the uncured portion 110b is removed, the cured exposed portion 110a forms projections 112. A PR pattern 115, which is formed by the regularly alternating channels 111 and projections 112, corresponds to a pattern of the finally obtained barrier ribs. That is, the channels 111 correspond to discharge spaces, in which plasma discharge occurs, and the projections 112 form a barrier rib that partitions the discharge spaces. The projections 112 can be frustum-shaped in cross-section, to facilitate removal of molding materials.

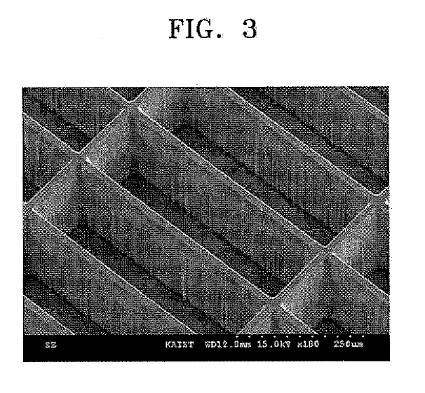

FIG. 3 is a photographic image showing a PR barrier rib pattern obtained using the above-described process. The PR barrier rib pattern may be formed as a matrix-type barrier rib pattern, and can include intersecting barrier ribs.

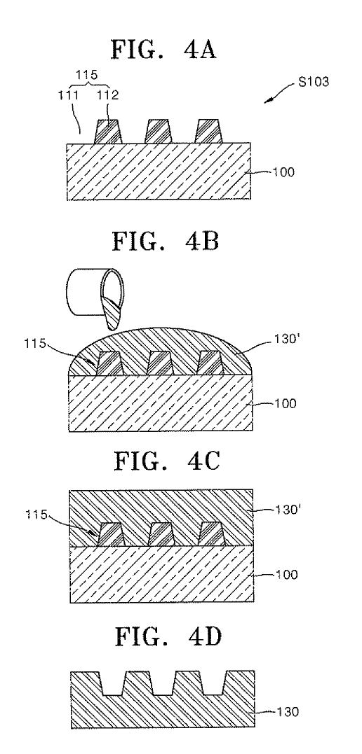

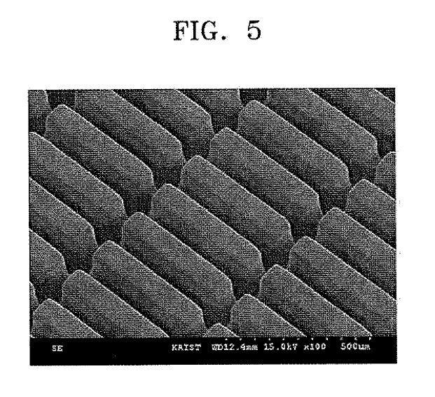

FIGS. 4A through 4D are cross-sectional views illustrating operation S103, wherein a pattern having an inverted image of the PR pattern 115, is reproduced using the PR pattern 115 as a mold, according to an exemplary embodiment of the present invention. Referring to FIGS. 4A and 4B, a shaping material 130′ is thickly coated on an embossed PR pattern 115, to fill the PR pattern 115. The shaping material 130′ contains silicon rubber and a hardening agent. The silicon rubber may be, for example, polydimethylsiloxane (PDMS) Sylgard 184A, from Dow Corning Corp. The silicon rubber and the hardening agent may be mixed in a ratio of 10 to 1. When air bubbles are interposed between the shaping material 130′ and the PR pattern 115, during the coating of the shaping material 130′, the channels 111 may remain unfilled. In order to overcome this problem, the shaping material 130′ may be coated in a vacuum chamber.

Referring to FIG. 4C, the PR pattern 115 is completely filled with the shaping material 130′. The resultant structure is cured at a predetermined temperature, and the PR pattern 115 is released, as shown in FIG. 4D. Since PDMS, which is the main component of the shaping material 130′, has a smooth surface and a low surface energy, it has excellent release characteristics. After releasing the PR pattern 115, a silicon mold 130, which has an inverted image of the PR pattern 115, and is patterned in intaglio, is obtained. FIG. 5 is a photographic of an intaglio pattern similar to that of the silicon mold 130.

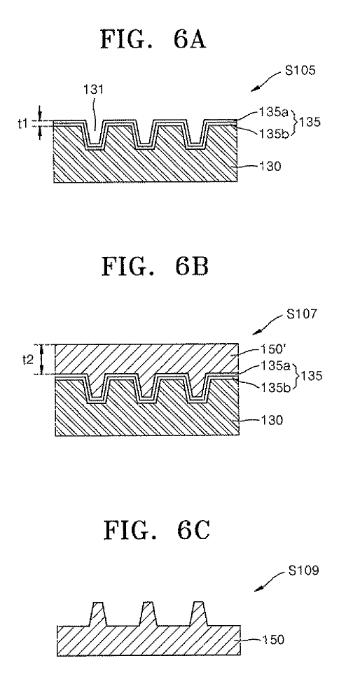

FIGS. 6A through 6C are cross-sectional views illustrating operations S105 to S109 of forming a metal mold 150 using the silicon mold 130, according to an exemplary embodiment of the present invention. Referring to FIG. 6A, a metal seed layer 135 is coated along the surface of the silicon mold 130. The metal seed layer 135 is used in an electroplating process that uses the metal seed layer 135 as one electrode, and a plated material as another electrode. Gold (Au), which has high electric conductivity, may be considered as a material for the metal seed layer 135. However, since the adhesion of Au with the silicon mold 130 is unreliable, a thin chrome (Cr) layer 135b is first deposited as an under layer, and then a thin Au layer 135a is formed thereon. The metal seed layer 135 should have a sufficient thickness t1, to allow the metal mold 150, which will be formed by electroplating, to be released from the silicon mold 130. Therefore, the Cr layer 135b may be formed to a thickness of about 1000 to 5000 Å, and the Au layer 135a may be formed to a thickness of about 1000 to 3000 Å. The Cr layer 135b and the Au layer 135a are provided only as exemplary materials used for electroplating, and other suitable materials may be substituted therefore.

Referring to FIG. 6B, after forming the metal seed layer 135, an electroplating process is performed, to form a metal plating layer 150′. Nickel (Ni) may be used as a plated material. During the electroplating process, the density of the metal plating layer 150′ depends on the current and voltage applied in the electroplating process. When the metal plating layer 150′ is formed to a thickness t2 sufficient to fill and cover the channels 131 of the silicon mold 130, the electroplating process is finished. As a result, an embossed pattern matching the silicon mold 130 is formed on a surface of the metal plating layer 150. Finally, referring to FIG. 6C, the metal mold 150 is released from the silicon mold 130.

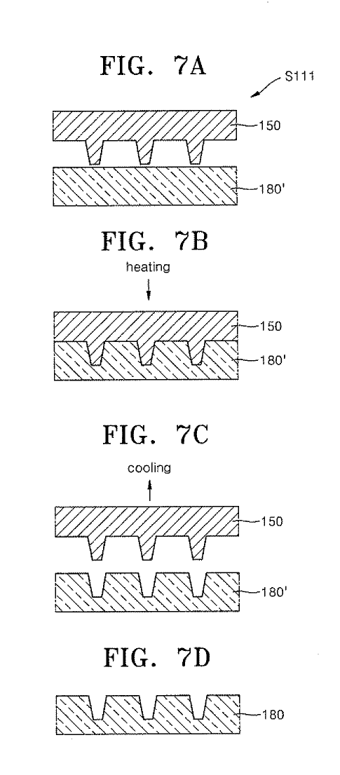

FIGS. 7A through 7D are cross-sectional views illustrating operation S111, wherein a soft mold 180 is formed using the metal mold 150, according to an exemplary embodiment of the present invention. The process illustrated in FIGS. 7A through 7D, is referred to as hot-embossing.

Referring to FIG. 7A, a polymer sheet 180′ is disposed under the metal mold 150. The polymer sheet 180′ may be one of various engineering plastics, such as, polycarbonate (PC), polymethyl methacrylate (PMMA), or polyethylene terephthalate (PT). Next, a pattern is transferred to the polymer sheet 180′. The transfer process is performed at a high temperature, in order to sufficiently shape the polymer sheet 180′. A specific process temperature may be optimized, considering a glass transition temperature of the polymer sheet 180′.

Referring to FIG. 7B, the metal mold 150 is imprinted onto the underlying polymer sheet 180′ under high temperature conditions, to form a pattern having an inverted image of the pattern of the metal mold 150. By applying a predetermined pressure to the metal mold 150 against the polymer sheet 180′, an embossed pattern of the metal mold 150 is transferred to the polymer sheet 180 in intaglio. Referring to FIG. 7C, the resultant structure is cooled over time to a normal temperature, such that the pattern of the metal mold 150 is sufficiently transferred onto the polymer sheet 180′. Referring to FIG. 7D, the metal mold 150 is released, thereby completing the manufacture of the soft mold 180.

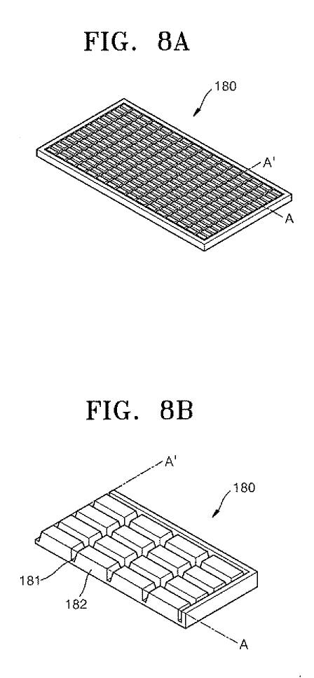

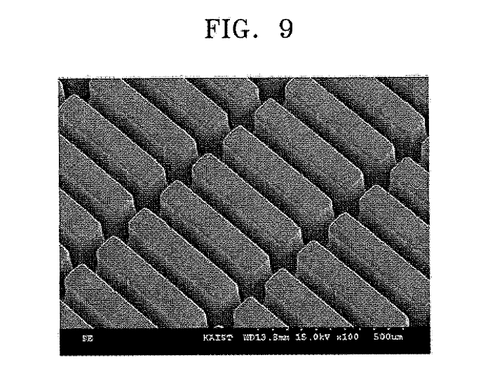

FIG. 8A is a perspective view of the soft mold 180 manufactured using the above-described method, and FIG. 8B is a partial cutaway perspective view, taken along a line A-A′ of FIG. 8A, according to an exemplary embodiment of the present invention. Referring to FIGS. 8A and 8B, the soft mold 180 includes projections 182, and channels 181, which together form a predetermined pattern on a surface thereof. The projections 182 form discharge spaces, during an imprinting process, performed on a barrier rib material. The channels 181 form projections making up a barrier rib to partition the discharge spaces, during the imprinting process. FIG. 9 is a photographic image of a soft mold formed of PET, which is obtained using the method illustrated in FIGS. 8A and 8B.

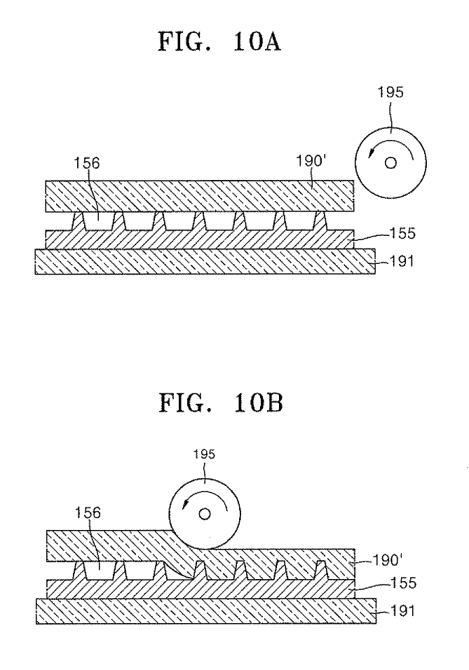

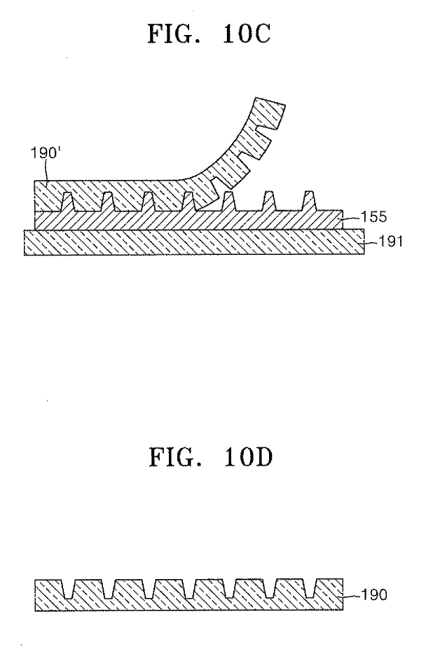

The method illustrated in FIGS. 7A through 7D is suitable to manufacture small and medium-sized soft molds of less than 40 square inches in area. Aspects of the present invention also provide an additional process that is suitable to manufacture a large-area soft mold, which will now be described with reference to FIGS. 10A through 10D.

Referring to FIG. 10A, a metal mold 155, which is manufactured using the above-described process, is located on a base substrate 191. Thereafter, a release agent (not shown) is coated along a surface of the metal mold 155. A polymer sheet 190′ is then disposed on the metal mold 155. Next, the pattern of the metal mold 155 is transferred to the polymer sheet 190′. The transfer process is performed at a high temperature, in order to sufficiently pattern the polymer sheet 190′. A specific process temperature may be optimized, by considering a glass transition temperature of the polymer sheet 190′.

Referring to FIG. 10B, a pressure roller 195 applies pressure to the polymer sheet 190′ at least once, from one end of the polymer sheet 190′ to the other end thereof, so that a channels 156 of the metal mold 155 are gradually filled with the polymer sheet 190′, thereby marking the polymer sheet 190′ with a pattern of the metal mold 155. An embossed pattern of the metal mold 155 is transferred to the polymer sheet 190′ in intaglio. The pressure is applied by the pressure roller 195, until the top surface of the polymer sheet 190′ is planarized, so that a uniform pattern is transferred to the entire surface of the polymer sheet 190′. Although the pressure roller 195, which rotates at uniform speed, is taken as an example of a pressure unit, the present invention is not limited thereto, and any type of compressing member, which contacts the polymer sheet 190′ and applies pressure thereto, may be used as the pressure unit.

Referring to FIGS. 10C and 1OD, the polymer sheet 190′ is released, and the metal mold 155 is removed, to complete the manufacture of a large-area soft mold 190. In order to produce the soft mold 190 in large quantities, the polymer sheets 190′ may be supplied one by one onto the metal mold 155. Alternatively, the polymer sheets 190′ may be wound as a roll around a supply roller, and cut one by one before and after a pattern transferring process.

A method of manufacturing a barrier rib of a plasma display panel (PDP), and a lower panel of the PDP, according to an exemplary embodiment of the present invention, will now be described. A process of manufacturing the barrier rib for the PDP will be described, along with a process of manufacturing the lower panel, since the two processes are performed consecutively.

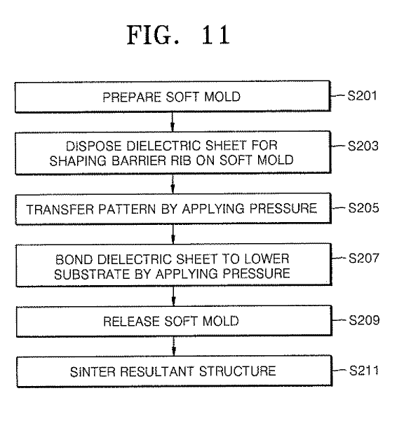

FIG. 11 is a process flowchart illustrating a method of manufacturing a lower panel of a plasma display panel (PDP), according to an embodiment of the present invention. Initially, a soft mold, having a top surface on which channels and projections corresponding to the shape of a barrier rib are disposed, is prepared in operation S201. A release agent (not shown) is uniformly coated along the top surface of the soft mold.

In operation S203, a dielectric sheet, as a material for the barrier rib, is disposed on the top surface of the soft mold, on which the release agent is coated. Thereafter, a barrier rib pattern formed on the soft mold is transferred onto the dielectric sheet, using a pressure roller, in operation S205. The dielectric sheet having the barrier rib pattern is disposed opposite a lower substrate. In operation S207, the dielectric sheet is bonded under pressure to the lower substrate, using the pressure roller. In operation S209, the soft mold is released. In operation S211, the barrier rib pattern formed on the dielectric sheet is sintered, thereby completing the manufacture of the lower panel.

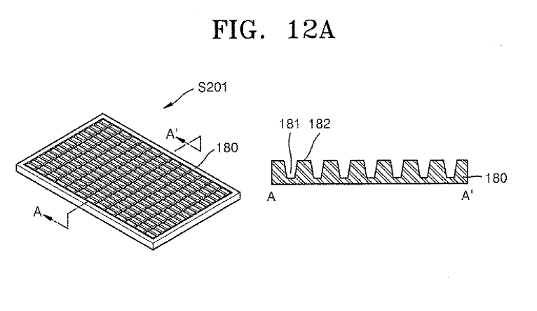

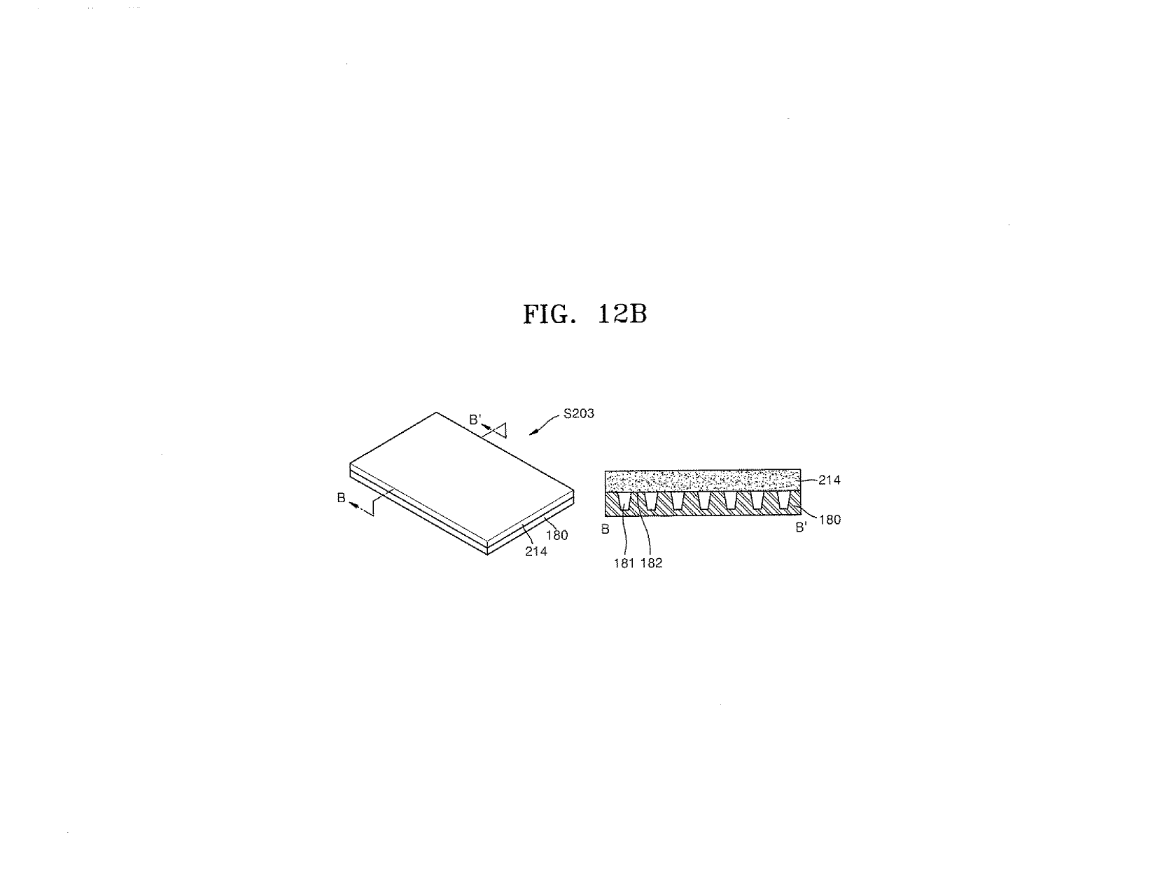

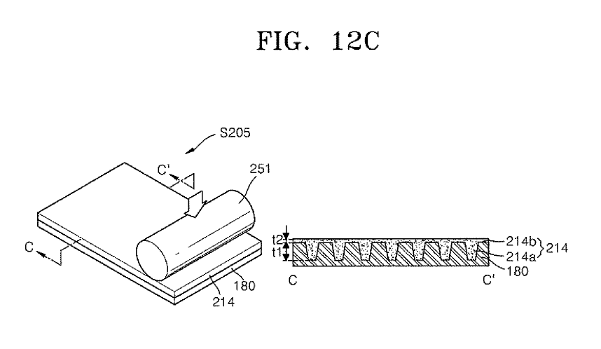

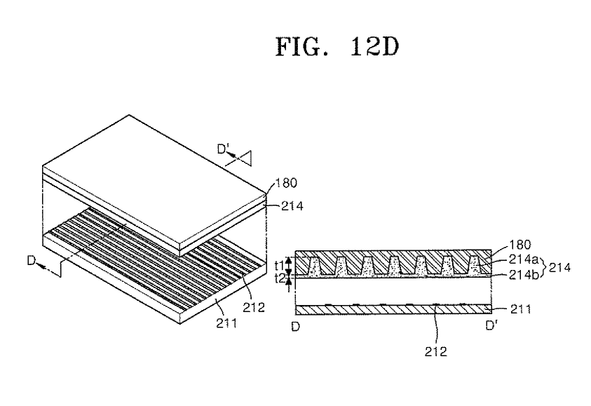

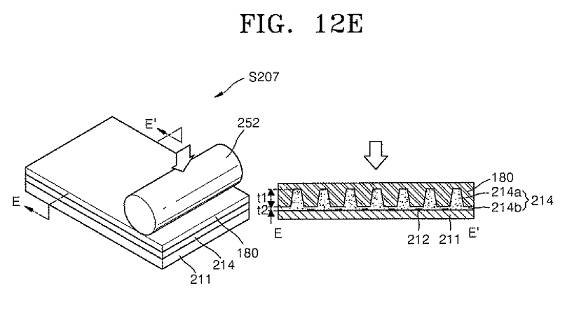

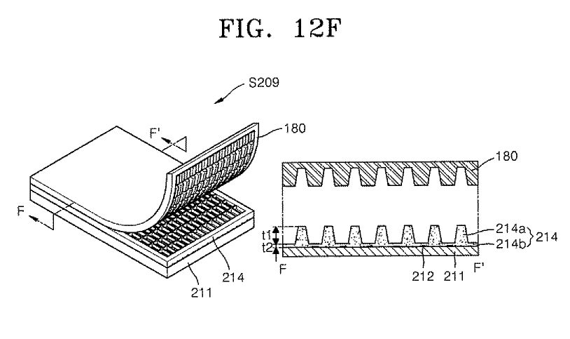

Hereinafter, operations S201 through S211 will be described in more detail, with reference to FIGS. 12A through 12F. FIGS. 12A through 12F are cross-sectional views illustrating the method of FIG. 11, according to an exemplary embodiment of the present invention. Referring to FIG. 12A, a soft mold 1801 having a top surface including a plurality of channels 181, and a plurality of projections 182 corresponding to the shape of a barrier rib, is prepared. Referring to FIG. 12B, the surface of the soft mold 180 is processed with a release agent, and a dielectric sheet 214, as a material for the barrier rib, is disposed on the soft mold 180.

Referring to FIG. 12C, a pressure roller 251 is brought into contact with the dielectric sheet 214, under a predetermined pressure, and moved from one end of the dielectric sheet 214 to the other end thereof at least once, at a constant rotation rate, so that a pattern of the soft mold 180 is imprinted to the dielectric sheet 214. In this case, the channels 181 of the soft mold 180 are forcibly filled with the dielectric sheet 214. The dielectric sheet 214 is shaped to have a rib portion 214a (projections) having a first thickness t1, and a substantially flat base portion 214b having a second thickness t2, due to the soft mold 180. The shaped dielectric sheet 214 may constitute a dielectric barrier rib. That is, the rib portion 214a of the shaped dielectric sheet 214 may be a barrier rib to at least partially define discharge spaces of a PDP. The base portion 214b of the shaped dielectric sheet 214 may be a dielectric layer, in which electrodes of the PDP are buried.

A first thickness t1 of the rib portion 214a is related to a dimension (height) of the discharge spaces (i.e., a height of the projections), and a second thickness t2 of the base portion 214b is sufficient to bury the electrodes. The thicknesses t1 and t2 can be controlled by adjusting the depth of the channels 181 of the soft mold 180, or the thickness of the dielectric sheet 214. In the method illustrated in FIG. 12C, since pressure is applied until the top surface of the dielectric sheet 214 is planarized, a uniform pattern can be formed throughout the dielectric sheet 214.

The dielectric sheet 214, which is patterned using the process described above, is pressed against a lower substrate 211. Referring to FIG. 12D, the lower substrate 211, on which a plurality of electrodes 212 are disposed, is prepared. Thereafter, the soft mold 180 and the dielectric sheet 214, which are pressure bonded to each other, are disposed on the exposed electrodes 212 of the lower substrate 211. In this case, the base portion 214b, of the dielectric sheet 214, is disposed upon the exposed electrodes 212 of the lower substrate 211.

Referring to FIG. 12E, a pressure roller 252 applies pressure to the soft mold 180 at least once, from one end of the soft mold 180 to the other end thereof, at a uniform rotation rate, so that the lower substrate 211 is pressure bonded to the dielectric sheet 214. The bonding process is continued until at least the exposed electrodes 212 of the lower substrate 211 are sufficiently covered, by the base portion 214b of the dielectric sheet 214, and the lower substrate 211 is reliably adhered to the dielectric sheet 214. Referring to FIG. 12F, the soft mold 180 is released. Finally, the resultant structure is sintered, thereby adhering the dielectric sheet 214 to the lower substrate 211.

According to the above-described method of manufacturing a lower panel of a PDP, a barrier rib pattern can be simply manufactured, by applying pressure to the soft mold, using a single transfer process, as compared with a conventional method that involves a series of complicated processes. For example, a barrier rib pattern can be formed by coating barrier rib paste on a substrate, forming a pattern mask for the barrier rib paste, and performing an etching process. Thus, aspects of the present invention provide a simple manufacturing process, as compared to the related art. In addition, a barrier rib and a dielectric layer are formed in a single process, according to aspects of the present invention.

Aspects of the present invention provide a dielectric barrier rib layer 214 including a base portion (dielectric layer) to cover electrodes, and a rib portion 214 (barrier rib) to partition discharge spaces. The dielectric barrier rib portion 214 can be formed using a single pressure-transfer process. Therefore, the method can greatly reduce the number of process operations. Meanwhile, although it is exemplarily described that the barrier rib portion 214 and the lower panel for the PDP are manufactured using a soft mold, the present invention is not limited thereto, and a hard mold, for example, may be used instead of the soft mold.

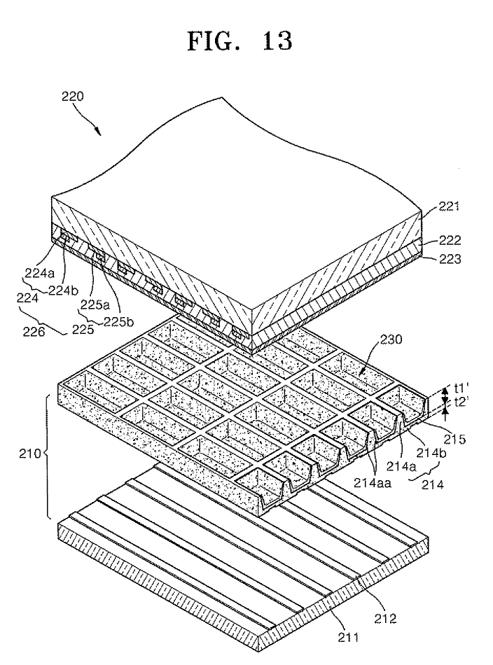

Hereinafter, a PDP manufactured according to the above-described method will be described with reference to FIG. 13. FIG. 13 is an exploded perspective view of a PDP, according to an exemplary embodiment of the present invention. Referring to FIG. 13, the PDP is largely divided into an upper panel 220 and a lower panel 210, which are bonded to each other. The upper panel 220 includes an upper substrate 221, electrode pairs 226, which include pairs of discharge electrodes 224 and sustain electrodes 226, and a dielectric layer 222 disposed on the upper substrate 221, to cover the pairs of discharge sustain electrodes 226. The lower panel 210 includes a lower substrate 211, a plurality of address electrodes 212 disposed on the lower substrate 211, and a barrier rib layer 214 interposed between the upper substrate 221 and the lower substrate 211, to partition a plurality of discharge spaces 230.

The upper substrate 221 may be a display surface, on which an image is projected. The upper substrate 221 may be a glass substrate having a good optical transparency. The lower substrate 211 also may be a glass substrate. However, in order to embody a flexible display, the upper and lower substrates 221 and 211 may be flexible plastic substrates having both optical transparency and flexibility.

The pairs of electrodes 226, disposed under the upper substrate 221, correspond to the discharge spaces 230. An alternating current (AC) signal with alternating sustain pulses, is applied between the pairs of discharge and sustain electrodes 226, to induce a sustain discharge in the corresponding discharge spaces 230. The discharge 224 and sustain electrodes 225 include transparent electrodes 224a and 225a, respectively, which extend across a row of discharge spaces 230, and bus electrodes 224b and 225b, respectively, which contact the transparent electrodes 224a and 225a, to supply driving power. However, the present invention is not limited to the above-described electrode structure.

The address electrodes 212 are disposed on the lower substrate 211, to form address discharges along with the discharge and sustain electrode 224 and 225. The address electrodes 212 may be arranged as stripes that extend at regular intervals, parallel to one another, and correspond to the respective discharge spaces 230.

The barrier rib layer 214 partitions the respective discharge spaces 230 into independent emission regions, and is disposed between the upper substrate 221 and the lower substrate 211, to prevent optical and electrical crosstalk. As described above, the barrier rib layer 214 is obtained by imprinting a soft mold (refer to 180 in FIG. 12F) having a barrier rib pattern, to the barrier rib layer 214 (refer to 214 in FIG. 12F). Thus, a rib portion 214a having a thickness t1′, which is patterned due to the soft mold, and a base portion 214b having a thickness t2′ (minimum thickness), are integrally formed in the barrier rib layer 214. The barrier rib layer 214 constitutes a dielectric barrier rib. That is, the rib portion 214a comprises projections and channels that form a barrier rib. The projections can be frustum-shaped in cross-section, to facilitate removal of the barrier rib layer 214 from the soft mold 180. The base portion 214b may serve as a dielectric layer that covers the address electrodes 212.

The base portion 214b covers and protects the underlying address electrodes 212, and cuts off an electrical conduction path between the address electrodes 212. The base portion 214b may be formed to a thickness t2′ that is sufficient to prevent the occurrence of an electrical breakdown. For example, the thickness t2′ may be a minimum thickness to cover the address electrodes 212.

Also, the rib portion 214a may be formed as a closed-type rib portion, to enclose all sides of the discharge spaces 230, or may be formed as an open-type rib portion, to open some sides of the discharge spaces 230, depending on the shape of the soft mold. For example, the closed-type rib portion may be formed as a matrix-type rib portion, with ribs intersecting each, other to partition discharge spaces having square cross-sections. In addition, the closed-type rib portion may partition polygonal discharge spaces, such as, pentagonal, or hexagonal, circular, or elliptical discharge spaces. Also, the open-type rib portion may be embodied by stripe patterns, but the present invention is not limited thereto.

Meanwhile, pattern sides 214aa that contact the discharge spaces 230, are not the etched surfaces formed using a conventional dry etching process, such as, a sandblasting process, or a wet etching process. The pattern sides 214aa are pressed surfaces formed by pressing the soft mold 180 in a downward direction. Also, since a conventional barrier rib, which is formed by filling a liquid photosensitive paste material in a mold, and curing the paste material by light, is not formed using an imprinting process, according aspects of the present invention. A conventional barrier rib, formed using a liquid photosensitive paste material, has sides that are shaped differently from the pattern sides 214aa. The pattern sides 214aa may be inclined at a predetermined angle (to form a frustum shape), considering the release of the barrier rib layer 214 from the soft mold 180. The barrier rib layer 214 is bonded under pressure to the lower substrate 211. Thus, an interface between the barrier rib layer 214 and the lower substrate 211 forms a pressure bond surface.

A phosphor layer 215 is formed in a region corresponding to each of the discharge spaces 230. For example, the phosphor layer 215 can include red (R), green (G), and blue (B) phosphor layers, which emit red, green and blue light, respectively, and are alternately coated on the pattern sides 214aa, and bottom surfaces of the discharge spaces 230. The respective discharge spaces 230 form R, G, and B sub-pixels, according to the type of the phosphor layer 215, which together form a unit pixel. However, the type of the phosphor layer 215 is not restricted to R, G, and B phosphor layers, and phosphor layers 215 having different colors may be additionally included, to increase the color purity of an image.

The barrier rib layer 214, according to an exemplary embodiment of the present invention, is formed from the rib portion 214a that partitions the discharge spaces 230. The base portion 214b is equivalent to a dielectric layer. The barrier rib layer 214 aids in shortening the manufacturing process, but the present invention is not limited thereto. For instance, in addition to the barrier rib layer 214, a separate dielectric layer (not shown), to cover the address electrodes 212, may be formed.

According to aspects of the present invention, a high-precision soft mold is provided, in order to form a high-resolution barrier rib pattern. Thus, a precise barrier rib pattern can be formed using the soft mold.

Aspects of the present invention provide a method of manufacturing the barrier rib pattern, by imprinting a soft mold onto a dielectric sheet, to shape a barrier rib. As compared with a conventional method, the manufacturing process, according to aspects of the present invention, is simple and convenient, and a pattern of the soft mold can be accurately transferred to the dielectric sheet. In particular, a dielectric barrier rib, which buries electrodes, and is a barrier rib to partition discharge spaces, can be formed using a single imprinting process. Therefore, the number of process operations can be greatly reduced, as compared with a conventional method, where a dielectric layer and a barrier rib are formed using separate processes.

Furthermore, according aspects of to the present invention, a PDP manufactured using the soft mold is provided. In the PDP, a barrier rib partitioning respective discharge spaces, as independent emission regions, can be accurately formed. Thus, the barrier rib has improved performance, thereby enhancing the image quality of the PDP.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A method of manufacturing a soft mold to form a barrier rib of a plasma display panel, comprising:
providing a metal mold having a barrier rib pattern of the plasma display panel, the barrier rib pattern formed of alternating channels and projections;
pressing the metal mold against a polymer sheet, to form an inverted image of the barrier rib pattern on a surface of the polymer sheet; and
releasing the polymer sheet from the metal mold, to form the soft mold.

2. The method of claim 1, wherein the providing of the metal mold comprises:
forming a barrier rib pattern on a first surface of a base substrate;
molding silicon to the first surface of the base substrate, to form a silicon mold having a patterned surface corresponding to an inversion of the barrier rib pattern;
forming a metal seed layer on the patterned surface of the silicon mold; and
electroplating a metal layer onto the seed layers to form the metal mold.

3. The method of claim 2, wherein the forming of the barrier rib pattern on the first surface of the base substrate comprises exposing and developing a photoresist (PR) layer, disposed on the base substrate, using a photolithographic process, to form projections extending from the base substrate, and channels separating the projections.

4. The method of claim 2, wherein the molding of the silicon comprises covering the barrier rib pattern with a silicon shaping material, and curing the silicon shaping material to form the silicon mold.

5. A method of manufacturing a barrier rib of a plasma display panel, the method comprising:
preparing a mold to shape a barrier rib, the mold having a patterned surface; and
pressing a dielectric sheet against the patterned surface of the mold to form a patterned first surface and an unpatterned opposing second surface on the dielectric sheet.

6. The method of claim 5, wherein the mold for the barrier rib is a soft mold formed by pressing a metal mold onto a polymer sheet, to form an inverted image of a barrier rib pattern from the metal mold, in a surface of the polymer sheet, and then releasing the polymer sheet from the metal mold, to form the soft mold.

7. The method of claim 5, wherein the dielectric sheet has a minimum thickness that is sufficient to cover address electrodes disposed on a substrate bonded to the dielectric sheet.

8. A method of manufacturing a lower panel of a plasma display panel, the method comprising:
preparing a mold to shape a barrier rib, the mold having a pattern on a surface thereof;
pressing a dielectric sheet into the mold, such that the dielectric sheet has a patterned first surface having projections that form a barrier rib pattern, and an opposing substantially flat second surface,
pressure bonding the second surface of the dielectric sheet to a substrate, to cover electrodes disposed on a surface of the substrate.

9. The method of claim 8, wherein the mold for the barrier rib is a soft mold formed by pressing a metal mold onto a polymer sheet, to form an inverted image of a barrier rib pattern from the metal mold, in a surface of the polymer sheet, and then releasing the polymer sheet from the metal mold, to form the soft mold.

10. The method of claim 8, wherein the pressure bonding comprises vertically aligning discharge spaces, at least partially defined by projections of the first surface, with the electrodes of the substrate, before pressure bonding the dielectric sheet to the substrate.

11. The method of claim 8, wherein, the pressure bonding of the dielectric sheet to the substrate comprises covering the electrodes of the substrate with the second surface of the dielectric sheet.

12. The method of claim 8, further comprising sintering the pressure bonded dielectric sheet and substrate.

13. A plasma display panel comprising:
a barrier rib layer comprising a first surface comprising projections that at least partially define discharge spaces, and a substantially flat opposing second surface;
an upper substrate disposed to face the first surface of the barrier rib layer;
a lower substrate disposed to face the second surface of the barrier rib layer;
a plurality of discharge electrodes extending across the discharge spaces;
phosphor layers disposed upon internal surfaces of the discharge spaces; and
a discharge gas filled in the discharge spaces.

14. The plasma display panel of claim 13, wherein the projections are formed in the first surface of the barrier rib layer by a molding process.

15. The plasma display panel of claim 13, wherein the projections are frustum-shaped in cross-section.

16. The method of claim 8, wherein the projections are frustum-shaped in cross-section.

17. The method of claim 1, wherein the soft mold comprises projections that are frustum-shaped in cross-section.
